(19) United States
(12) Patent Application Publication
(10) Pub. No.: US 2008/0048459 A1
(43) Pub. Date: Feb. 28, 2008

(54) Keybolt assembly

(76) Inventor: Shih-Hao Fang, Taipei (TW)

Correspondence Address: COOPER & DUNHAM, LLP, 1185 AVENUE OF THE AMERICAS, NEW YORK, NY, 10036, US

(21) Appl. No.: 11/509,533

(22) Filed: Aug. 24, 2006

(51) Int. Cl. E05C 19/00

(52) U.S. Cl. 292/252

(57) ABSTRACT

A keybolt assembly has a body and a latching element. The body has a recess and a detent assembly. The recess is defined in the body and has an inner surface and a notch formed longitudinally in the inner surface of the recess. The detent assembly is mounted in the notch to position the latching element. The latching element is mounted rotatably in the recess of the body, is elongated and has multiple detents. The detents are formed in a side surface of the latching element along a major axis and a minor axis of the latching element to selectively engage with the detent assembly to keep the latching element in a lock position.

### BACKGROUND OF THE INVENTION

1. Field of the Invention

The present invention relates to a keybolt, and more particularly to a keybolt assembly that is manually operable and is unitary which avoids the loss of a pin, hair pin or any other fastening element.

2. Description of Related Art

Keybolts are used to fasten mounting members. With reference to FIG. 7, a conventional keybolt (50) is mounted in an axial aperture (41) of a mounting member (40) and is provided with a hair pin (52). The conventional keybolt (50) has two ends. One of the ends of the conventional keybolt (50) has a bending portion that prevents the keybolt (50) disengaging from the aperture (41). The other end of the conventional keybolt (50) is a latching end. An annular groove (51) is defined radially around a surface of the conventional keybolt (50) near the latching end. The hair pin (52) clamps the annular groove (51) to keep the conventional keybolt (50) in the aperture (41), so as to fasten mounting members.

Otherwise, with further reference to FIG. 8, another conventional keybolt (60) is provided with a pin (62). The conventional keybolt (60) has a through hole (61) formed radially through the conventional keybolt (60). The pin (62) is mounted through the through hole (61) and protrudes out of the through hole (61) to keep the conventional keybolt (60) in the aperture (41), such to fasten mounting members.

However, said fastening element like the hair pin (52) or the pin (62) are not permanently mounted with the conventional keybolt (50)(60), so that said fastening element is probably lost. Once the fastening element lost, the conventional keybolt (50)(60) is accordingly unable to be used for connection until a replacement is available.

Furthermore, the conventional keybolts (50)(60) are retained in a locked position by the fastening elements. If the fastening elements become loosen or damaged, the conventional keybolts may be unsteady and the connection between the mounting members becomes weak.

To overcome the shortcomings, the present invention provides a keybolt assembly to obviate or mitigate the aforementioned problems.

### SUMMARY OF THE INVENTION

The main objective of the present invention is to provide a keybolt assembly that is manually operable and is unitary which avoids the loss of a pin, hair pin or any other fastening element.

Another objective of the present invention is to provide a keybolt assembly that is steady when retaining in a locked position.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a keybolt assembly in accordance with the present invention;

FIG. 2 is a partial cross sectional side view of the keybolt assembly in FIG. 1;

FIG. 3 is a top view of the keybolt assembly in FIG. 1 with internal elements shown in phantom lines;

FIG. 4 is an another partial cross sectional side view of the keybolt assembly in FIG. 1;

FIG. 5 is an another top view of the keybolt assembly in FIG. 1 with internal elements shown in phantom lines;

FIG. 6 is an operational perspective view of the keybolt assembly in FIG. 1;

FIG. 7 is an operational perspective view of a conventional keybolt assembly in accordance with the prior art; and

FIG. 8 is an operational perspective view of another conventional keybolt assembly in accordance with the prior art.

### DETAILED DESCRIPTION OF THE PREFERRED EMBODIMENT

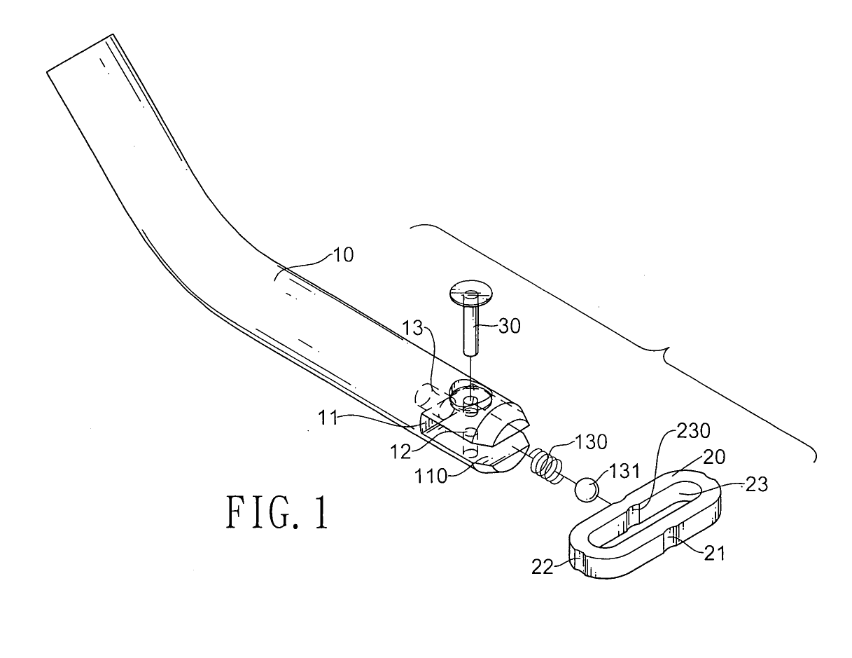

With reference to FIG. 1, the keybolt assembly in accordance with the present invention comprises a body (10), a latching element (20) and a fastener (30).

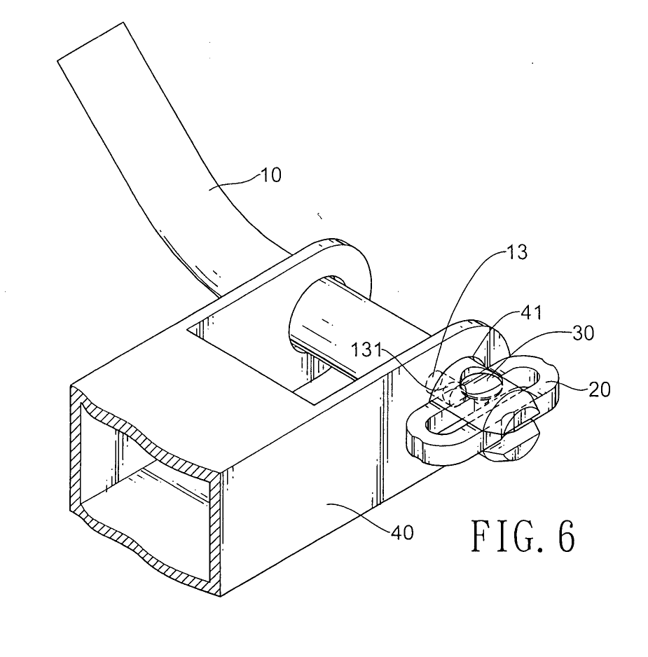

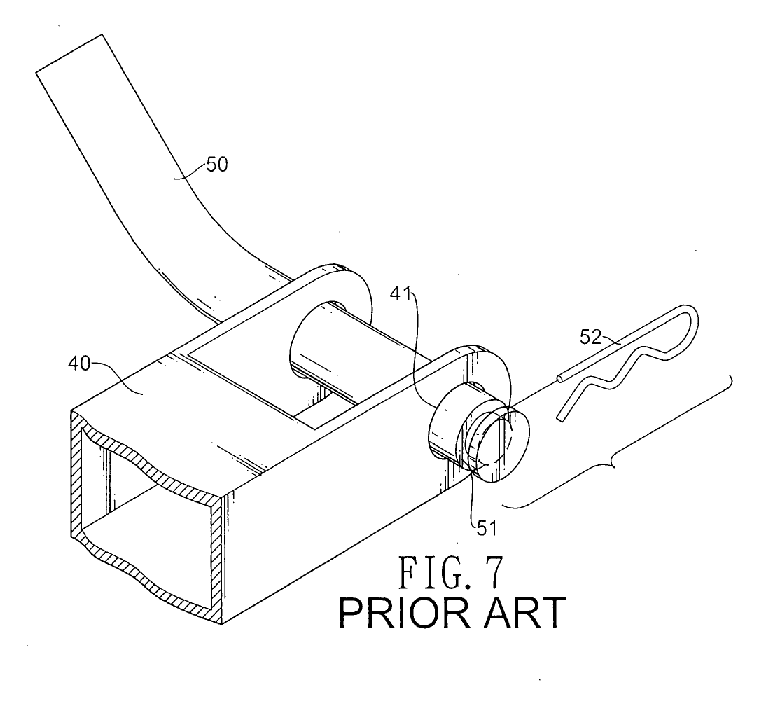

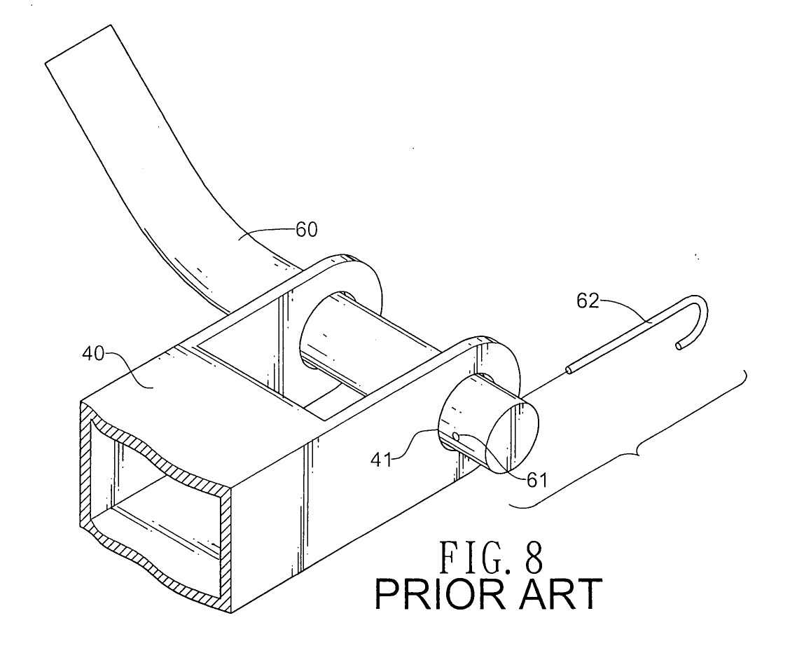

With further reference to FIG. 6, the body (10) extends through apertures (41) of a mounting member (40) and has a bending end and a latching end. The bending end prevents the keybolt assembly disengaging from the apertures (41) of the mounting member (40). The latching end has two tongues (110), a recess (11) and a detent assembly. The tongues (110) are axially formed separately on the latching end. Each tongue (110) has a mounting hole (12) formed radially through the tongue (110). The mounting holes (12) of the tongues (110) align with each other. The recess (11) is defined between the tongues (110) and has an inner surface and a notch (13). The notch (13) is formed longitudinally in the inner surface of the recess (11) and has a depth.

The detent assembly is mounted in the notch (13) to selectively position the latching element (20) and comprises a resilient element (130) and a ball (131). The resilient element (130) is mounted in the notch (13) and has two ends and a length shorter than the depth of the notch (13). The ball (131) is mounted in the notch (13), abuts one of the ends of the resilient element (130) and slightly protrudes out of the notch (13).

The latching element (20) is mounted rotatably in the recess (11) of the body (10) between the tongues (110), is an oval-shaped ring and has a major axis, a minor axis, a side surface, two first detents (22), two second detents (21) and a central hole (23). The first detents (22) are formed respectively in the side surface along the major axis of the latching element (20) and selectively engage with the ball (131). The second detents (21) are formed respectively in the side surface along the minor axis of the latching element (20) and selectively engage with the ball (131). The central hole (23) is defined through the latching element (20), is elongate and has two end, an inner surface and two grooves (230) formed oppositely in the inner surface of the central hole (23) along the minor axis of the latching element (20).

The fastener (30) may be a rivet, is received slidably through the central hole (23) of the latching element (20), is mounted securely in the mounting holes (12) in the tongues (110) to mount the latching element (20) rotatably on the body (10) and has an outer surface. The outer surface of the fastener (30) selectively engages with one of the grooves (230) in the central hole (23) of the latching element (20) to provide an additional positioning effect.

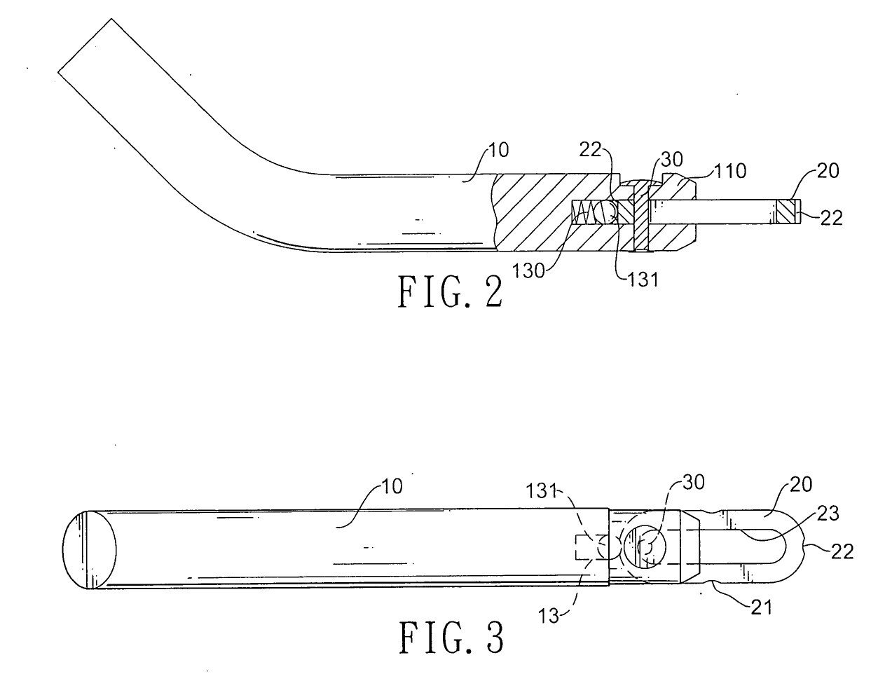

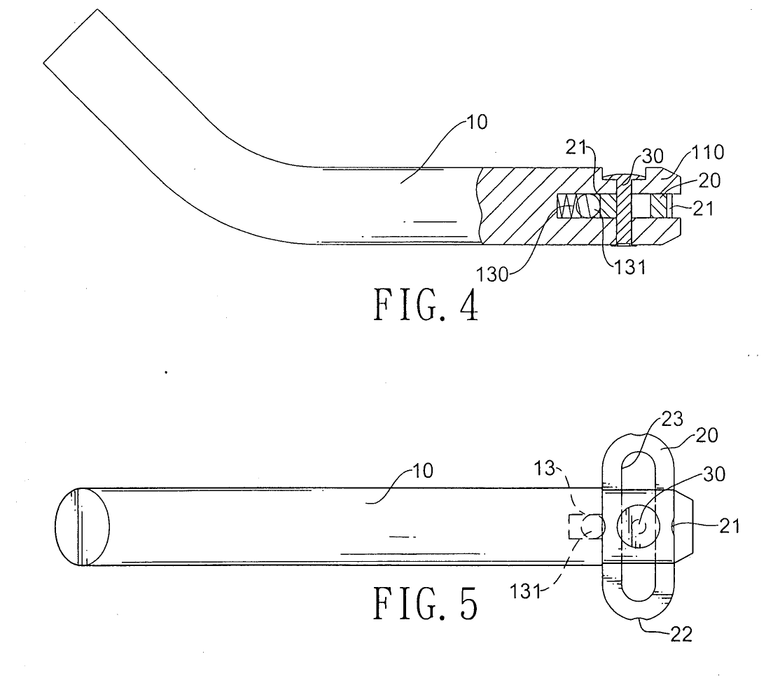

With reference to FIGS. 2, 3 and 6, when the major axis of the latching element (20) aligns with the axis of the body (10), the latching element (20) is at an original position. The ball (131) is pushed by the resilient element (130) and engages one of the first detents (22) of the latching element (20) to keep the latching element (20) in the original position. Thus, a user can put the keybolt assembly into an aperture (41) of the mounting element (40) easily.

With further reference to FIGS. 4, 5 and 6, after the keybolt assembly put into the aperture (41), the user can manually rotate the latching element (20) to let the minor axis of the latching element (30) align with the axis of the body (10). Then, the ball (131) is pushed by the resilient element (130) and engages one of the second detents (21) of the latching element (20). Meanwhile, the outer surface of the fastener (30) engages one of the grooves (230) of the central hole (23) and provides an additional positioning effect to retain the latching element (20) steady in the lock position.

Accordingly, Since users can manually rotate the latching element (20), the keybolt assembly in accordance with the present invention can be easily used to connect mounting members. Moreover, with the latching element (20) is mounted rotatably and not detachably on the body (10), the latching element (30) will not be lost and connection between the mounting members is tight.

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. A keybolt assembly comprising
a body having
a bending end; and
a latching end having
two tongues axially formed separately on the latching end, and each tongue having a mounting hole formed radially through the tongue, wherein the mounting holes of the tongues align with each other;
a recess being defined between the tongues; and having
an inner surface; and
a notch being formed longitudinally in the inner surface of the recess and having a depth; and
a detent assembly being mounted in the notch to selectively position the latching element;
a latching element being mounted rotatably in the recess of the body between the tongues, being elongated and having a central hole being defined through the latching element, being elongate and having two ends and an inner surface; and
a fastener being received slidably through the central hole of the latching element and mounted securely in the mounting holes in the tongues.

2. The keybolt assembly as claimed in claim 1, wherein
the detent assembly comprises
a resilient element being mounted in the notch and having two ends and a length shorter than the depth of the notch; and
a ball being mounted in the notch, abutting one of the ends of the resilient element and slightly protruding out of the notch; and
the latching element further has
a major axis;
a minor axis;
a side surface;
two first detents being formed respectively in the side surface along the major axis of the latching element and selectively engaging with the ball; and
two second detents being formed respectively in the side surface along the minor axis of the latching element and selectively engaging with the ball.

3. The keybolt assembly as claimed in claim 2, wherein
the central hole of the latching element further has two grooves formed oppositely in the inner surface of the central hole along the minor axis of the latching element; and the fastener has an outer surface selectively engaging with one of the grooves in the central hole of the latching element.

4. The keybolt assembly as claimed in claim 3, wherein the latching element is an elongated oval-shaped ring.

5. The as claimed in claim 4, wherein the fastener is a rivet.
